(19) United States
(12) Patent Application Publication
(10) Pub. No.: US 2017/0058205 A1
(43) Pub. Date: Mar. 2, 2017

(54) Non-Oxidized Desulfurization Process and Method of Using the Same

(71) Applicant: SpinTek Filtration, Inc., Los Alamitos, CA (US)

(72) Inventors: Tekliong Ho, Los Alamitos, CA (US); Luay Albakri, Los Alamitos, CA (US); William Greene, Long Beach, CA (US)

(21) Appl. No.: 14/843,232

(22) Filed: Sep. 2, 2015

(51) Int. Cl. C10G 25/00; B01J 20/08; B01J 20/06; B01D 15/00; B01J 20/02; B01J 20/28; C10L 1/04; B01J 20/10; B01J 20/18

(52) U.S. Cl. CPC C10G 25/003; C10G 25/00; B01J 20/103; B01J 20/08; B01J 20/06; B01J 20/18; B01J 20/0229; B01J 20/0225; B01J 20/0244; B01J 20/0222; B01J 20/0218; B01J 20/28059; B01J 20/28061; C10L 1/04; B01D 15/00; C10L 2270/02; C10L 2270/04; C10L 2290/542

(57) ABSTRACT

A non-oxidized diesel desulfurization process that uses temperature swing adsorption along with an adsorbent to adsorb sulfur compounds and other impurities petroleum-based from fuel compositions, including light distillates, middle distillates, diesel, gasoline and transmix. The process uses temperature cycling of an adsorbent bed to adsorb and desorb organosulfur compounds and other impurities. Once the adsorbent reaches a selected concentration of sulfur compounds, the temperature of the adsorbent bed is raised to desorb sulfur compounds, using a regenerant.

### FIELD OF THE INVENTION

The present invention relates generally to a desulfurization process for removing sulfur compounds and other impurities from petroleum-based fuel compositions.

### BACKGROUND OF THE INVENTION

Sulfur-containing compounds are a component in petroleum-based fuels that can potentially form harmful compounds in the environment when the fuel is ignited or combusted. The sulfur-containing compounds can be converted into sulfur dioxide, which can then be converted into sulfur-based acids in the atmosphere. The acids are then mixed with rain to form so-called “acid rain.” In addition, sulfur-containing compounds can also reduce the effectiveness of catalytic converters, leading to an increase in nitrous oxide (NOₓ) emissions.

In order to reduce air pollution and the negative environmental impact associated with petroleum-based fuels, various technologies have been developed to reduce sulfur and other harmful emissions while maintaining fuel efficiency. Fuel quality standards have been imposed for the control of such emissions through the reduction in sulfur content in petroleum-based fuels.

Sulfur contents in crude oils may include the following:
1) Free elemental sulfur;
2) Mercaptans and thiols (R—SH);
3) Hydrogen sulfide;
4) Sulfides;
5) Disulfides (R—S—S—R′);
6) Poly sulfides (R—Sₙ—R′); and
7) Thiophenes and their derivatives (including benzothiophenes and dibenzothiophenes.

Petroleum products are usually grouped into several categories: light distillates (LPG, gasoline, naphtha), middle distillates (kerosene, diesel), and heavy distillates and residuum (heavy fuel oil, lubricating oils, wax, asphalt). This classification is based on the way crude oil is distilled and separated into fractions.

Diesel is a multi-purpose middle distillate petroleum fuel that is widely used in trucks, trains, boats, buses, planes, heavy machinery and off-road vehicles. It also remains one of the largest sources of fine particulate air pollution. Sulfur, a natural part of the crude oil from which diesel fuel is derived, is one of the key causes of particulates or soot in diesel. Soot is the main culprit of diesel engines' noxious black exhaust fumes, and is among the prime contributors to air pollution. Besides soot, diesel fueled engines also emit nitrogen oxides that can form ground level ozone.

Beginning in 2001, the U.S. Environmental Protection Agency passed rules requiring the use of ultra-low sulfur diesel (ULSD) in diesel engines including trucks, buses, construction equipment, as well as stationary sources. ULSD must be refined so that its sulfur content is 15 parts per million (ppm) or less. The move toward ULSD is aimed at lowering diesel engines' harmful exhaust emissions and improving air quality. Low-sulfur fuel is typically defined as having less than 500 ppm sulfur, and uncontrolled sulfur diesel may have levels that are much higher.

It is generally known that the sulfur content in diesel and other fuels can be reduced by hydrodesulfurization (HDS), which is a standard desulfurization process in the oil/petrochemical industry. Hydrodesulfurization involves contacting of hydrogen with the hydrocarbon stream in a packed bed reactor in the presence of a catalyst at elevated temperatures and pressures to convert sulfur products present therein into hydrogen sulfide. The catalysts used in the HDS process typically comprise ruthenium and/or transitional metals. While ruthenium is the most active catalyst, it is also expensive and relatively toxic, which has led to the extensive use of transitional metal catalyst binary metals on various catalyst supports. These transitional metal catalysts include, but are not limited to, molybdenum-cobalt, nickel-tungsten and nickel-molybdenum, among others. Nickel-tungsten and nickel molybdenum are commonly used for processing middle distillate, which typically contains organic nitrogen compounds and the ability to remove organic nitrogen by uses of these catalysts is essential for increasing the effectiveness of the desulfurization process. The hydrogen sulfide gas produced may then be subsequently converted into byproduct elemental sulfur or sulfuric acid.

Hydrodesulfurization processes are described, for example, in U.S. Pat. No. 6,126,814 to Lapinski et al., U.S. Pat. No. 6,013,598 to Lapinski et al. and in U.S. Pat. No. 5,985,136 to Brignac et al., the subject matter of each of which is herein incorporated by reference in its entirety. In one such process, diesel with a high sulfur content goes through two consecutive stages of hydrogen treatment: the first stage removes smaller sulfur compound molecules and thereafter the second stage removes larger molecules. The first stage operates at a temperature of about 300° C. and a pressure of about 650 psi. This high temperature and pressure is necessary to reduce the wetting barrier between solid, diesel and hydrogen. The second stage operates at a temperature of about 400° C. and a pressure of about 850 psi. This higher temperature in the second stage is required to mitigate the higher resistance to mass transfer of the more sterically hindered sulfur compounds such as benzothiophenes, dibenzothiophenes, etc.

However, the hydrodesulfurization process not only reduces the amount of sulfur and sulfur-containing compounds in the fuel, but also breaks apart olefins and reduces the amount of other heteroatom-containing compounds, including nitrogen-containing and oxygen-containing compounds in the fuel, and reduces the aromatic amount in the middle distillate. Breaking middle distillate fuel into a lighter gas is not economical since the middle distillate is more valuable than that of the byproduct gases. In addition, reducing aromatics in the middle distillate has adverse effects on the fuel quality, including reducing lubricity, increasing tear-wear in pistons, lowering the efficiency of the engine and increasing engine knocking. The hydrodesulfurization process is also unable to achieve ultra-low sulfur levels in the fuel due to the low reactivity of refractory sulfur species under conventional conditions and also strong inhibition of the reaction by the reaction products H₂S, NH₃, nitrogen and aromatic species.

To achieve the required reductions in sulfur content in the fuel, the operating conditions of hydrogen desulfurization need to be more severe with respect to both temperature and pressure, which can also lead to an increased process cost. Furthermore, while the concentration of thiophenes and, to a lesser extent, benzothiophenes can be reduced to the required levels by hydrodesulfurization, the reduction in concentration of other sulfur species, such as dialkyl dibenzothiophenes can be more problematic.

More recently, an oxidative desulfurization (ODS) process has been developed, as described, for example, in U.S. Pat. No. 8,088,711 to Choi and U.S. Pat. No. 8,016,999 to Borgna et al., the subject matter of each of which is herein incorporated by reference in its entirety. In the ODS process, the fuel is contacted with an oxidant such as hydrogen peroxide, ozone, nitrogen dioxide, or tert-butyl-hydroperoxide, in order to selectively oxidize the sulfur compounds present in the fuel to polar organic compounds. These polar compounds can be easily separated from the hydrophobic hydrocarbon based fuel via solvent (liquid) extraction using solvents such as alcohols, amines, ketones or aldehydes, for example. This process operates at ambient temperature and pressure, which allows for a significant cost reduction.

However, the catalysts used in this process typically comprise phosphate derivatives, tungstate derivatives, etc., which are generally non-regenerable. The catalysts are usually added into organic liquids prior to being mixed with the middle distillate or other fuel. Organic peroxide is one of the most commonly used oxidizing agents in the ODS process and the use and storage of organic peroxide can be hazardous, causing safety concerns. After oxidation, the organic sulfur compounds are extracted from the hydrocarbon using an organic liquid, such as acetonitrile. During the extraction of sulfone, large amounts of hydrocarbons are also removed from the middle distillate into an acetonitrile phase. In addition, the sulfoxide created by ODS cannot be treated by HDS.

Thus, it can be seen that there remains a need in the art for an improved process for removing sulfur compounds from petroleum-based fuel that overcomes the deficiencies of the prior art.

### SUMMARY OF THE INVENTION

It is an object of the present invention to provide an efficient method of reducing the sulfur content of petroleum-based fuel feed stocks.

It is another object of the present invention to provide an efficient method of producing diesel or other middle-distillate fuel that is substantially free of sulfur and other impurities.

It is another object of the present invention to provide a method of removing sulfur and other impurities from petroleum-based fuel feed stocks that does not require high temperatures.

It is still another object of the present invention to provide a method of removing sulfur and other impurities from petroleum-based fuel feed stocks that does not require high pressures.

It is still another object of the present invention to provide a method of removing sulfur and other impurities from petroleum-based fuel feed stocks that is non-selective.

It is still another object of the present invention to provide a method of removing sulfur and other impurities from petroleum-based fuel feed stocks using an adsorbent that is reusable.

It is still another object of the present invention to provide a method of removing sulfur and other impurities from petroleum-based fuel feed stocks using an adsorbent that is regenerable.

To that end, in one embodiment, the present invention relates generally to a method for removing impurities from a petroleum-based fuel composition using temperature swing adsorption, the method comprising the steps of:

a) feeding a petroleum-based fuel composition containing impurities to a series of packed bed columns, wherein the series of packed bed columns comprise an adsorbent capable of adsorbing the impurities from the petroleum-based feed composition at a first temperature;

b) adsorbing the impurities in the petroleum-based feed composition onto the adsorbent in the series of packed columns at the first temperature; and

c) removing treated petroleum-based fuel from the series of packed bed columns.

In another embodiment, the present invention relates generally to a temperature swing adsorption system for removing impurities from a petroleum-based fuel composition, the temperature swing adsorption system comprising:

a. a plurality of packed bed adsorbers, wherein the plurality of packed bed adsorbers are arranged in an N+1 configuration, wherein N packed bed adsorbers operate in series and one adsorber is offline, and wherein the plurality of packed bed adsorbers comprise an adsorbent capable of adsorbing impurities from the petroleum-based fuel composition at a first temperature;

b. an inlet for feeding the petroleum-based fuel composition to be treated into the plurality of packed bed adsorbers;

c. an outlet for removing the treated petroleum-based fuel composition from the plurality of packed bed adsorbers; and

d. means for controlling temperature and pressure in the system.

In another embodiment, the present invention relates generally to an adsorbent for removing impurities from a petroleum-based fuel composition in a temperature swing adsorption process, wherein the adsorbent comprises a porous support impregnated with a sorbent mixture.

### BRIEF DESCRIPTION OF THE FIGURES

For a fuller understanding of the invention, reference is had to the following description taken in connection with the accompanying figures, in which:

FIG. 1 depicts a flow configuration of a packed bed system in accordance with the present invention.

FIG. 2 depicts a flow configuration in which a portion of the ultra-low sulfur diesel produced in the manner described herein is used as the regenerant.

FIG. 3 depicts a flow configuration in which a polar solvent, such as ethanol, is used as the regenerant.

FIG. 4 depicts test results showing that repeating the regeneration process on the adsorbents does not affect the sulfur removal of the adsorbent.

FIG. 5 shows the relationship between the height of an adsorber with the number of regenerations per day.

FIG. 6 depicts an example of the relationship between the total height of unit reactors and the height of a unit reactor depending on the breakthrough point and concentration of sulfur compounds in the feed flow.

FIG. 7 depicts the relationship of the production rate of clean diesel to the amount of adsorbent used and the type of regenerant used to regenerate the adsorbent.

Also, while not all elements may be labeled in each figure, all elements with the same reference number indicate similar or identical parts.

### DETAILED DESCRIPTION OF THE PREFERRED EMBODIMENTS

As described herein, temperature swing adsorption (TSA) is a process in which an adsorption phase and a de-sorption phase of the process use the same fluid, but take place at two different temperatures. As the temperature of the adsorption process changes, the activity of the liquid molecules also changes, including, for example, the viscosity, surface tension between liquid and adsorbent surfaces, capillary effect in the pores, etc.

The inventors of the present invention have discovered that TSA can be used for the removal of organic sulfur compounds and other impurities from petroleum-based fuels in a simple and efficient manner that overcomes many of the deficiencies of the prior art. Thus, as described herein, desulfurization of middle distillate and other petroleum-based fuels may be carried out by moving organic sulfur compounds and other impurities in the middle distillate or other petroleum-based fuel onto an adsorbent in a packed bed system. The system is a cyclic process of adsorption and desorption, controlled by changing the temperature of the adsorbent bed. During the desorption process, the adsorbent is stripped of the organic sulfur compounds, allowing the adsorbent to be reused.

Based thereon, in one embodiment, the present invention relates generally to a method for removing impurities from a petroleum-based fuel composition using temperature swing adsorption, the method comprising the steps of:

a) feeding a petroleum-based fuel composition containing impurities to a series of packed bed columns, wherein the series of packed bed columns comprise an adsorbent capable of adsorbing the impurities from the petroleum-based feed composition at a first temperature;

b) adsorbing the impurities in the petroleum-based feed composition onto the adsorbent in the series of packed columns at the first temperature; and

c) removing treated petroleum-based fuel from the series of packed bed columns.

The petroleum-based fuel composition may be selected from the group consisting of light distillates, middle distillates, gasoline, diesel, transmix and combinations of one or more of the foregoing. The process described herein significantly reduces the sulfur content of petroleum-based fuel compositions such as diesel fuel, jet fuel, off-road fuel, locomotive fuel, marine fuel, reformulated fuel, convention fuel, bath fuel, previously certified gasoline, previously designated diesel fuel, blend stocks or transmix by way of example and not limitation. The amount of sulfur removed from the feedstock will depend in part on the initial sulfur concentration of sulfur in the feedstock as well as the required sulfur content of the treated fuel. In one embodiment, the fuel produced may be an ultra-low sulfur fuel, such as ultra-low sulfur diesel fuel. Furthermore, by ultra-low sulfur fuel, what is meant is that fuel contains less than about 15 parts per million sulfur. In another embodiment, the fuel produced may be a reduced sulfur fuel, including reduced sulfur and low sulfur diesel and middle distillates fuels having a sulfur concentration of less than about 500 parts per million, more preferably a sulfur content of less than about 150 parts per million.

As described herein, transmix refers to a transportation mixture that is produced when refined petroleum products such as gasoline and diesel mix together. When combined, these products no longer meet approved specifications and cannot be used. Thus, a transmix processing unit is used to distill transmix into various types and grades of gasoline and diesel so that the distillate products can be used as transportation fuel.

The process described herein is capable of removing most, if not all, of the sulfur compounds and other impurities in the fuel composition non-selectively. In contrast to ODS, this adsorption process requires no oxidation or chemical additions and any concentrated sulfur compounds can be sent, if necessary to a subsequent hydrodesulfurization process. Because the HDS process is more cost effective and efficient at higher sulfur concentrations, the process described herein enables the use of smaller HDS reactors for a given sulfur throughput, or, alternatively, higher throughput capacity in an existing HDS using lower energy/operating costs and hydrogen usage.

In some embodiments, the reduced sulfur or low sulfur fuel composition produced in the process may be formulated to include one or more of detergents, dispersants, deposit control additives, carburetor detergents, intake valve deposit detergents, intake system detergents, combustion chamber deposit control additives, fuel injector detergents, fluidizing agents, carrier oils and polymers, corrosion inhibitors, antioxidants, metal surface deactivators, metal surface passivators, combustion enhancing additives, cold-starting aids, spark promoters, spark improvers, spark plug detergents, surfactants, viscosity improvers, viscosity modifying agents, friction modifiers, fuel injection spray modifiers, fuel injection spray enhancers, fuel droplet size modification agents, volatility agents, oxygenates, water demulsifiers, water-rejection agents, water-separation agents, deicers, and combinations of one or more of the foregoing as would generally be known to those skilled in the art.

The present invention features a unique adsorbent in a system of packed bed adsorbers and uses TSA to remove sulfur compounds and other impurities from a fuel stream containing sulfur and other impurities.

This process uses well established packed bed technology, employing packed beds in vertical columns run in series, with one column offline at any time for regeneration. As used herein, sulfur compounds include, but are not limited to sulfur, hydrogen sulfide, carbonyl sulfuride and other organosulfur compounds such as mercaptans, thiophenic compounds found in cracked gasolines, including thiophenes, benzothiophenes, alkyl thiophenes, alkyl benzothiophenes and alkylbenzothiophenes among others.

The process of the invention can be used as a stand-alone system or as a pre-concentrator for other sulfur treatment systems such as HDS. As a preconditioner to HDS, it improves the efficiency of HDS, can be used to alleviate bottlenecking in HDS plants, reduces operating costs and lowers hydrogen usage.

Unlike ODS systems that are based upon oxidation using potentially very dangerous chemicals, the process described herein does not require any oxidation or chemical addition. Unlike ODS systems that convert the sulfur compounds to sulfoxide, making them untreatable by HDS, the process described herein does not chemically modify the sulfur compounds.

The efficiency of the process described herein is highly dependent on the properties of the adsorbent that is used in the process.

Ideally, the adsorbent should exhibit the following properties:
1) a high adsorption capacity for the impurities (i.e., organosulfur compounds) which are to be removed;
2) a good regeneration capacity (the impurities must be capable of being desorbed under reasonable temperature and pressure conditions);
3) a good mechanical strength; and
4) a service lifetime which is as long as possible.

In another preferred embodiment, as described herein, the present invention also relates generally to an adsorbent for removing impurities from a petroleum-based fuel composition in a temperature swing adsorption process, wherein the adsorbent comprises a porous support impregnated with a sorbent mixture.

The porous support may be selected from the group consisting of alumina, zirconia, silica gel, molecular sieves and combinations of one or more of the foregoing. In a preferred embodiment, the porous support comprises activated alumina.

The sorbent mixture preferably comprises a cation selected from the group consisting of chromium, manganese, iron, cobalt, nickel, copper, zinc and combinations of one or more of the foregoing. In a preferred embodiment, the sorbent mixture comprises nickel oxide. In addition, the sorbent mixture may also comprise a second cation. Optionally, the sorbent mixture may also contain a filler or binder.

The concentration of the sorbent mixture on the porous support is preferably within the range of about 0.01 to about 20 percent by weight, more preferably within the range of about 1.0 percent, to about 15 percent by weight, and most preferably within the range of about 2.0 to about 10 percent by weight of the adsorbent composition.

The adsorbent also preferably has a BET surface area within the range of about 50 to about 350 m²/gram, more preferably within the range of about 80 to about 300 m²/gram.

As described herein the adsorbent is capable of adsorbing impurities from a petroleum-based fuel composition at a first lower temperature and desorbing the impurities to a regenerant at a second higher temperature.

The adsorption process is typically conducted at a temperature of about 0° C. to about 100° C. as the feed stream passes through the packed column of adsorbent material, more preferably at a temperature of between about 20° C. and about 80° C. The pressure of the adsorption process as the feed stream passes through the packed column of adsorbent material is typically between about 5 and about 120 psia, more preferably about 10 to about 100 psia.

In addition, the desorption process is typically conducted at a temperature of about 10° C. to about 200° C. as the feed stream passes through the packed column of adsorbent material, more preferably at a temperature of between about 20° C. and about 175° C. The pressure of the adsorption process as the feed stream passes through the packed column of adsorbent material is typically between about 5 and about 120 psia, more preferably about 10 to about 100 psia.

Steps a) through c) above may be repeated until the adsorbent in at least one of the packed bed columns in the series of packed bed columns reaches a predetermined concentration of impurities or at a set time interval. In one embodiment, steps a) through c) are repeated until the adsorbent in the at least one of the packed bed columns reaches equilibrium, whereby the adsorbent in the at least one of the packed bed columns is loaded with or nearly loaded with the impurities.

Thereafter, the bed that is loaded with or that otherwise contains impurities can be taken offline for regeneration.

The bed that contains impurities is regenerated by:

d) raising the temperature of the at least one bed that contains impurities to a second temperature at which the impurities are capable of desorbing from the adsorbent; and

e) feeding a regenerant solution to a top of the at least one bed that contains impurities and removing the regenerant from a bottom of the last least one bed, wherein the impurities desorb from the adsorbent into the regenerant solution.

If desired, the concentrated regenerant solution output containing the reabsorbed impurities can be sent to an HDS or other system for further processing.

In another embodiment, the bed that contains impurities may be regenerated by adding a heated regenerant solution to a top of the at least one bed that contains impurities without changing the temperature of the bed. Therefore, in this embodiment the regenerant, and not the bed itself, is heated to a second temperature at which the impurities are capable of desorbing from the adsorbent into the regenerant solution.

The strip off or regenerant for the adsorbent is preferably selected from the group consisting of middle distillate, organic solvents, water, and combinations of one or more of the foregoing. In one embodiment, the regenerant may be the reduced sulfur, low sulfur or ultra-low sulfur diesel or middle distillate produced in the process, and a portion of the reduced sulfur, low sulfur or ultra-low sulfur diesel or middle distillate produced in the process may be stored for use as the regenerant.

The temperature during the regeneration phase may be within the range of about 10° C. to about 175° C., depending in part on the particular regenerant used. For example, if the regenerant is ultra-low sulfur diesel, the second temperature may be within the range of about 125° C. to about 175° C. On the other hand, if the regenerant is ethanol or a similar polar solvent, the second temperature may be within the range of about 70° C. to about 100° C.

The adsorption time of the process typically requires about 5 and about 140 minutes, depending on the initial concentration of the impurities in the feedstock, the allowable final concentration of impurities (if any), the temperature and pressure of the system, the number of packed beds, among other factors.

The adsorbent described herein adsorbs by physisorption. In physisorption, the adsorbate is bound to the adsorbent by the weak interaction known as Van der Walls force. This weak attraction allows for easy, low temperature regeneration. An alternative adsorption process uses chemisorption. In chemisorption, the adsorbate is bound to the adsorbent with a chemical bond. This chemical bond is much stronger that the Van der Walls attraction in physisorption, enabling the use of a smaller bed due to faster adsorption and higher loading at low sulfur concentrations in the gas phase, but requires more energy to break during regeneration, necessitating higher temperature and the use of chemical agents.

The slow rate of physisorption, as compared with chemisorption, can be remedied by increasing the bed temperature to speed up mass transfer of sulfur compounds. Because the equilibrium constant in the direction of adsorption decreases with increasing temperature, an optimum temperature must be selected to ensure rapid adsorption as well as sufficient bed loading for economical operation.

The present invention also relates generally to a temperature swing adsorption system for removing organic sulfur compounds and other impurities from a petroleum-based fuel composition, the temperature swing adsorption system comprising:

a. a plurality of packed bed adsorbers, wherein the plurality of packed bed adsorbers are arranged in an N+1 configuration, wherein N packed bed adsorbers operate in series to adsorb impurities from the petroleum-based fuel composition and one adsorber is offline, and wherein the plurality of packed bed adsorbers comprise an adsorbent capable of adsorbing impurities from the petroleum-based fuel composition at a first temperature;

b. an inlet for feeding the petroleum-based fuel composition to be treated into the N packed bed adsorbers;

c. an outlet for removing the treated petroleum-based fuel composition from the N packed bed adsorbers; and

d. means for controlling temperature and pressure in the system.

The packed bed system described herein comprises packed bed adsorbers that are operated in series in an N+1 configuration. At any time, N units are in an adsorption mode and one unit is in desorption or regeneration mode. It is further noted that N is at least 1, and depending on the system may be at least 2 or at least 3 or more.

Furthermore, each bed of the series of N packed bed columns operates in an upflow, whereby the petroleum-based fuel composition enters the bottom of each bed and is removed from the top of each bed in the series of N packed bed columns.

As discussed above, the system may be operated until the adsorbent in at least one of the packed bed columns in the series of packed bed columns reaches a selected concentration, which may be equilibrium or another selected concentration, or alternatively for a selected period of time, whereby the adsorbent in the at least one of the packed bed columns contains impurities. Thereafter, the bed that contains impurities is taken offline to regenerate the at least one bed.

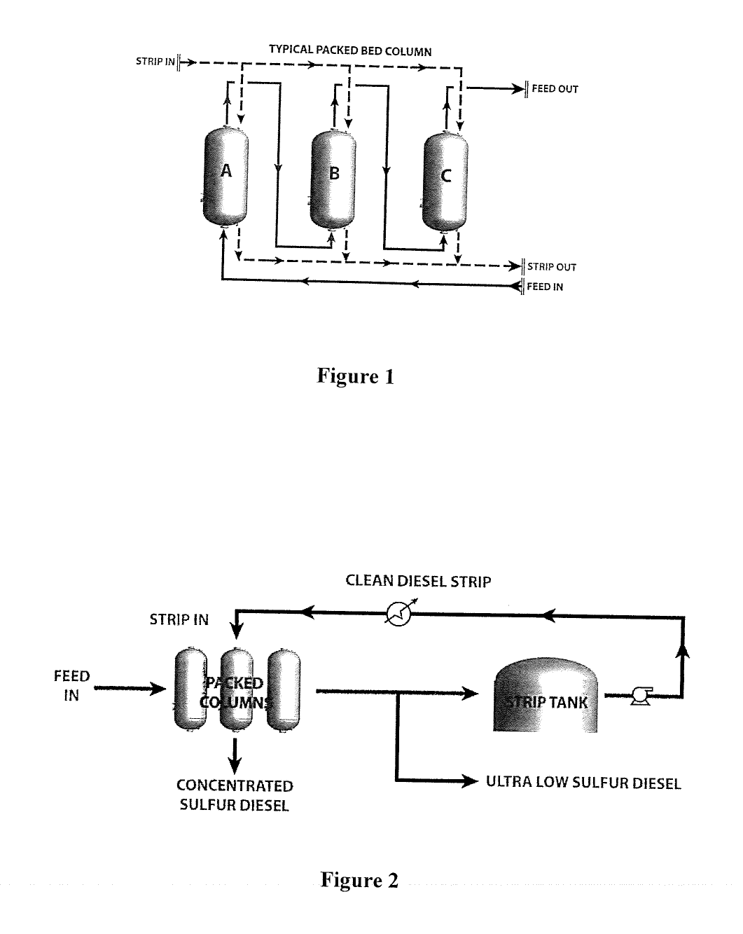

FIG. 1 illustrates a flow configuration of a packed bed system in accordance with the present invention. As shown in FIG. 1, the lead vessel in the flow sequence is the vessel that is next to be regenerated. Each bed in adsorption mode operates in upflow; diesel is fed to the adsorber vessel below the bed, flows up through the bed and exits the vessel above the bed. The bed in regeneration mode operates in downflow; clean diesel is sprayed onto the bed from above, flows down through the bed and exit the vessel below the bed.

The untreated diesel entering the process flows first to the lead vessel and then to the polishing vessel, and then exits the process as treated product. Once it is a determined that a bed contains a certain concentration of sulfur compounds or after a period of time, it may be taken off line for regeneration. In the 2+1 system shown in the process schematic in FIG. 1, the unit last regenerated is placed into adsorption as the polishing vessel and the unit next to be regenerated is placed in front as the lead vessel. The vessel sequencing is depicted as I to II to III and back to I.

FIG. 2 illustrates a flow configuration in which a portion of the ultra-low sulfur diesel produced in the manner described herein is used as the regenerant. Thus, it can be seen that there are no chemicals involved in either the processing or the regenerating phases of the process.

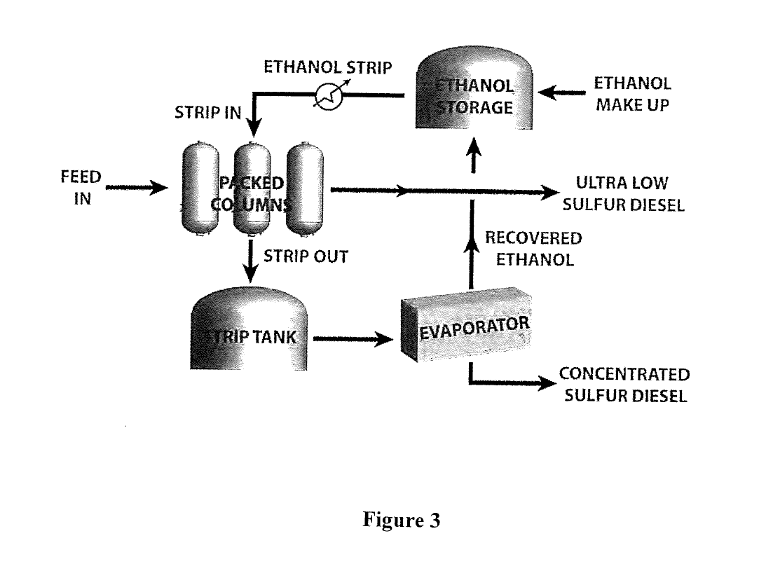

In an alternate process, and as depicted in FIG. 3, a polar solvent, such as ethanol, is used as the regenerant. The use of ethanol, as shown in FIG. 3, has the advantage of increasing the ratio of service ULSD to concentrated sulfur but has the disadvantage of requiring both ethanol and an evaporator to separate the strip diesel and ethanol back into separate streams.

As described above, the temperature of the regeneration process depends in part on the regenerant used to regeneration the adsorbent blend. For example, if ULSD is used as the regenerant, a regeneration processing temperature of about 125 to about 175° C. is required, while if ethanol is used as the regenerant, a temperature of about 70 to about 100° C. can be used. Thus, if a different regenerant is used, the optimum temperature can be determined by one skilled in the art.

The amount of regenerant needed for regeneration depends on the volume of the beds. Higher bed volume produces more product but requires more regenerant to regenerate the adsorbents.

### EXAMPLES

### Example 1

Ethanol was used in durability studies because it is harsher on the adsorbent described herein than ultra-low sulfur diesel. The adsorption capability of the adsorbent was measured to detect any adverse effects from repeated use and regeneration.

The test procedure in batch reactors was as follows:

1. Diesel and adsorbent in weight ratio of 5:1 were mixed at room temperature.

2. After reaching an equilibrium point, diesel was taken for analysis.

3. The adsorbent was washed with ethanol and dried.

4. The adsorbent was mixed again with new diesel at the same ratio as before.

5. Steps 1 through 4 were repeated 10 times.

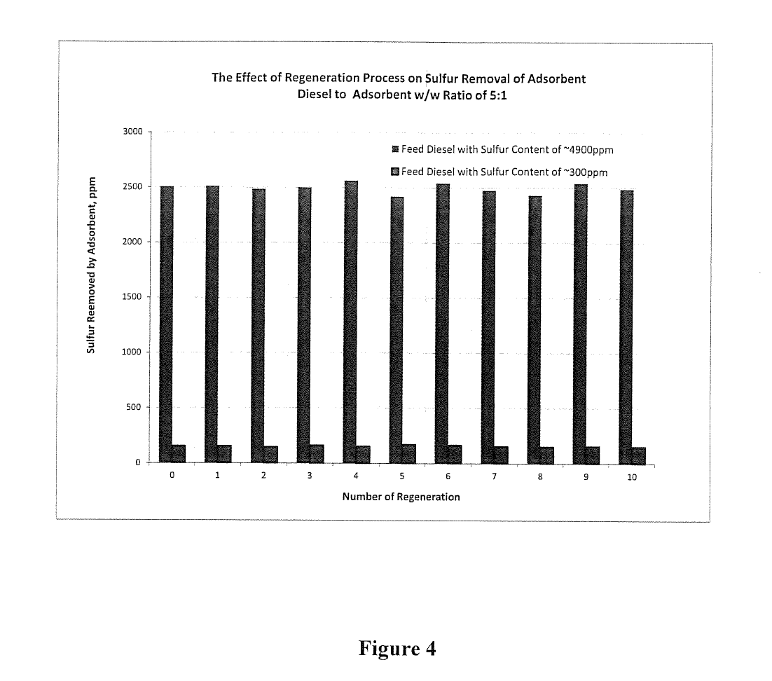

Two sets of tests were run for two diesel compositions with different sulfur concentrations, 4900 ppm and at 300 ppm respectively. The diesels containing the recited sulfur concentrations were mixed with adsorbent at a constant weight ratio of 5:1 repeatedly. Test results demonstrated that repeating the regeneration process on the adsorbents did not affect the sulfur removal of the adsorbent as shown in FIG. 4.

The process parameters used for this example were as follows:

Temperature: 60° C.

Pressure: Ambient

Bed height: Set by sulfur concentration in feed and in the final product

Bed diameter: Set by flow rate of feed and velocity of upflow

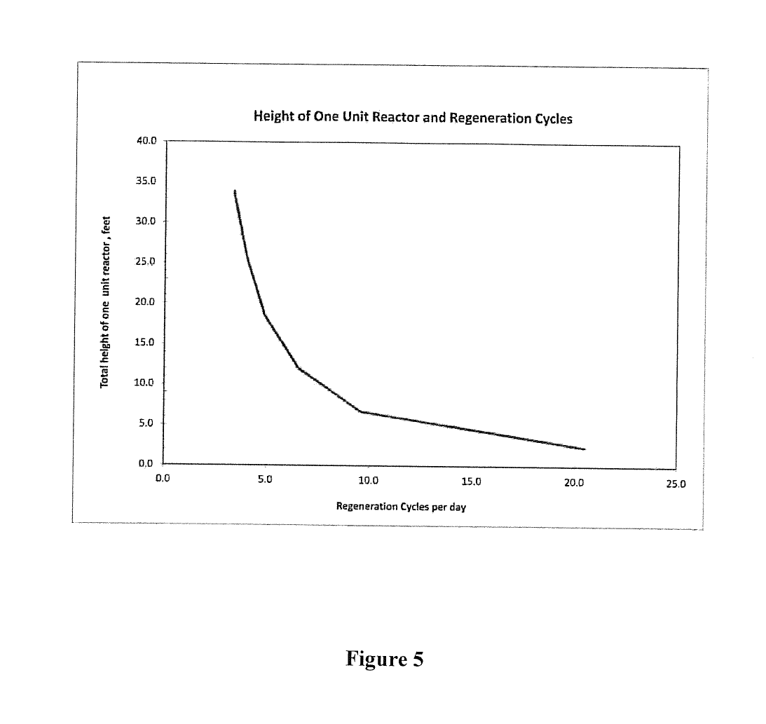

The height of each adsorber and the number of adsorbers required may be determined based on the desired number of regenerations per day. FIG. 5 shows the relationship between the height of one unit reactor and the number of regenerations per day. Thus, it can be seen that a taller unit reactor runs longer between regenerations and thus needs fewer regeneration cycles per day.

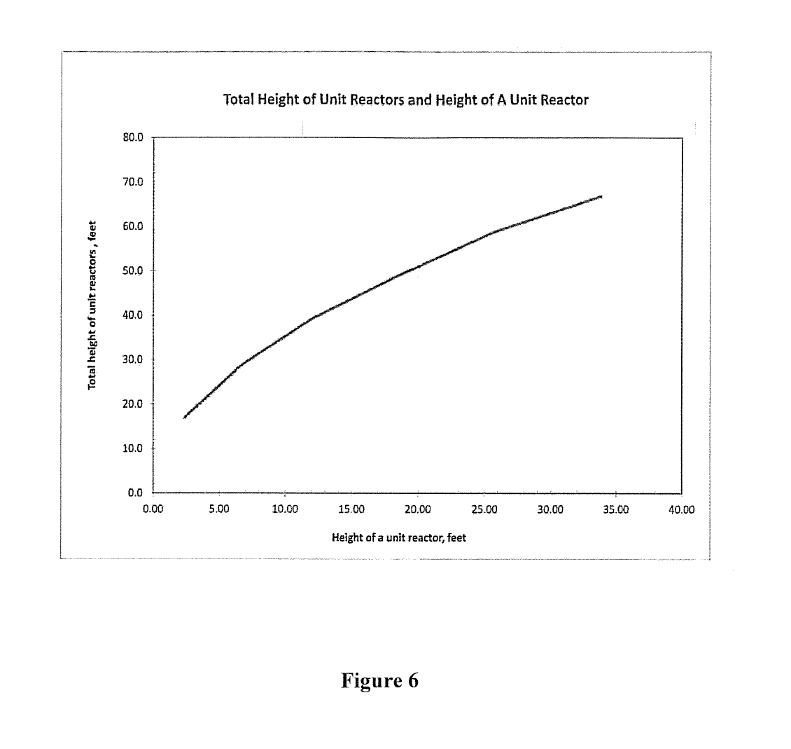

The height of the adsorption beds can be calculated based on the length of the time interval between when a bed is put into adsorption mode after regeneration and the time it becomes fully loaded, as detected by a rise in the sulfur concentration in the product stream to 10 ppm. FIG. 6 depicts an example of the relationship between the total height of unit reactors and the height of a unit reactor depending on the breakthrough point and concentration of sulfur compound in the feed flow.

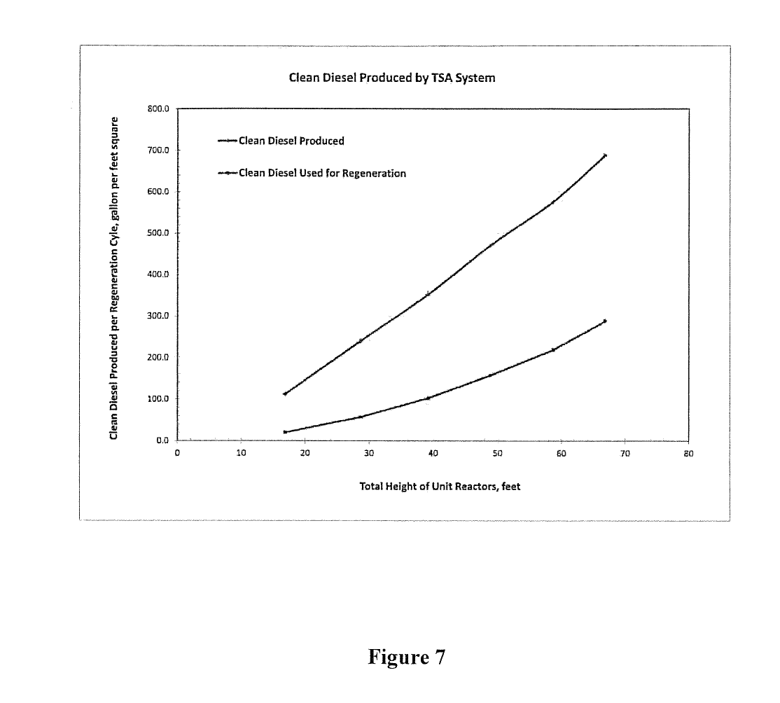

The production rate of clean diesel is related to the amount of adsorbent used and the type of regenerant used to regenerate the adsorbent. As shown in FIG. 7, the total clean diesel produced is either:
1. The difference between the amount of gross product and the amount of product used to regenerate the bed; or
2. Using ethanol as a regenerating agent, the amount of ultraclean diesel produced is the amount of gross product

The results indicate that the most suitable condition of operation is between about 20 and about 80° C. and a flow rate of between about 1.0 and about 3.0 m/ft². Higher temperature improves transport properties of the liquid and reduces its surface tension which improves capillary effects in the micropores. Higher temperature also increases the polarity of sulfur compounds, which strengthens the weak attraction between sulfur compounds and adsorbent. The adsorption is slower when the bed temperature is below 60° C. At lower temperatures, the physical attraction between adsorbent and sulfur compounds in liquid diesel is weaker and the mass transfer of the sulfur compounds from macropores to micropores is slower.

Increasing the temperature of the adsorption process increases the rate of adsorption of sulfur compounds in diesel. The unfavorable entropic effect of higher temperature on adsorption in general is ameliorated by the increased polarity of the sulfur compounds, which is due to increased entropy of the molecular bonds in their more polar configuration.

In a physisorption process, the end of adsorption is always at an equilibrium point; the amount of adsorbate on the adsorbent will be in equilibrium with certain concentration of adsorbate in the liquid with which it is in contact. The adsorption stops when the rates of adsorption and desorption are equal to each other (equilibrium point). As shown in Table 1 below, the equilibrium point varies with the concentration of adsorbent in the feed flow.

TABLE 1
Initial and Final Sulfur Content in Diesel

| Sulfur concentration | Maximum sulfur |
|---|---|
| in feed | adsorbed on adsorbent |
| (ppm) | (mg of S/g of adsorbent) |
| ~4900 | 40 |
| ~2900 | 19 |
| ~300 | 5.6 |

The relationship between the equilibrium point and the concentration of sulfur compounds in diesel liquid can be modeled based on the Dubinin-Radushkevich isotherm model which is generally applied to express the adsorption mechanism with a Gaussian energy distribution onto a heterogeneous surface and can be calculated based on the following formulae:

qₑ=(qₛ)exp(−K_{ad}ε²) (1)

ln qₑ=ln(qₛ)−(K_{ad}ε²) (2)

Where qₑ is the amount of adsorbate in the adsorbent at equilibrium (mg/g), qₛ is the theoretical isotherm saturation capacity (mg/g), K_{ad} is the Dubinin-Radushkevich isotherm constant (mol²/kJ²) and ε is the potential energy.

One of the unique features of the Dubinin-Radushkevich isotherm models is that it is temperature-dependent, which when adsorption data at different temperatures are plotted as a function of logarithm of amount absorbed lnqₑ vs ε², the square of potential energy, all suitable data will lie on the same curve, named as the characteristic curve.

In the event of increasing temperature, the rate of desorption will run faster than the adsorption rate. Consequently, the adsorbed sulfur compounds on the adsorbent begin leaving the adsorbent back to the petroleum-based fuel.

### Example 2

The following tables demonstrate a typical process calculations for sizing a temperature swing adsorption system in accordance with the present invention.

The first requirement is to input the amount of petroleum-based fuel, such as crude and/or diesel, to be processed and the level of sulfur contained therein. Thereafter, the diameter, column area, and working bed height of the packed bed columns can be calculated as shown in Tables 2 through 4.

TABLE 2
Crude processing:

| | | |
|---|---|---|
| Crude rate | 20,000 | BPD |
| Ratio of diesel to crude | 25% | |
| Diesel rate | 5,000 | BPD |

TABLE 3
Columns for diesel processing:

| | | |
|---|---|---|
| Diesel rate | 5,000 | BPD |
| Length of run | 24 | Hours |
| Diesel/run | 5,000 | B/run |
| Diesel/run | 794,850 | liters/run |
| Sulfur compounds | 300 | mg/l |
| Sulfur compounds | 238,455,000 | mg/run |
| Working bed loading | 2.5 | mg/gram adsorbent |
| Adsorbent required | 95,382,000 | grams/run |
| Bulk density of adsorbent | 30,232 | grams/ft³ |
| Working bed volume | 3,155 | ft³ |

TABLE 4
Column selection:

| | | |
|---|---|---|
| Column diameter | 10.5 | ft |
| Column area | 86.59 | ft² |
| Working bed height | 36.44 | ft |

This example uses a configuration in which two columns are used for removal of sulfur from the petroleum-based fuel feed and one column is used for regeneration as shown in Table 5. Furthermore, as discussed above, other configurations, including those using three or four or more columns in series can also be used and the calculations described herein can be performed for other system configurations.

TABLE 5
Column operating configuration:

| | | |
|---|---|---|
| Columns in parallel | 1 | |
| Columns in series | 2 | |
| Columns in regeneration | 1 | |
| Total number of columns | 3 | |
| Height of each bed/run | 18.22 | ft |

Based thereon, the flow rate, column area, and volumetric flux can be determined for this particular system as shown in Table 6.

TABLE 6
Flow calculation:

| | | |
|---|---|---|
| Flow rate | 146 | gpm |
| Columns in parallel | 1 | |
| Column area | 86.59 | ft² |
| Volumetric flux | 1.68 | gpm/ft² |

Using this information, the ratio of clean diesel to concentrate is determined and the ratio of ULSD to concentration is calculated along with sulfur levels as shown in Table 7.

TABLE 7
Mass balance per run:

| | | |
|---|---|---|
| Ratio of product to concentrate | 3.00 | V/V |
| Inlet flow | 5,000 | B/run |
| Product flow | 3,750 | B/run |
| Concentrate flow | 1,250 | B/run |
| Total sulfur in | 238,455,000 | mg/run |
| Inlet flow | 794,850 | liters/run |
| Product flow | 596,138 | liters/run |
| Concentrate flow | 198,713 | liters/run |
| Product concentration | 10 | mg/l |
| Sulfur out in product | 5,961,375 | mg/run |
| Sulfur out in concentrate | 232,493,625 | mg/run |
| Sulfur concentration in concentrate | 1,170 | mg/l |

The operating costs for a typical temperature swing adsorption system in accordance with the present invention include:

1) energy to heat diesel to the adsorption temperature;
2) energy to pump diesel through the adsorber bed;
3) energy to heat the regenerant to the regeneration temperature; and
4) energy to pump the regenerant through the adsorber bed.
Typical energy requirements for adsorption and desorption are shown in Tables 8 and 9.

TABLE 8
Energy requirements, adsorption:

| | | |
|---|---|---|
| Diesel temperature in | 25 | ° C. |
| Diesel temperature out | 60 | ° C. |
| Diesel flow rate | 146 | GPM |
| Diesel flow rate | 60,569 | lb/hr |
| Diesel heat capacity | 0.43 | Btu/lb-° F. |
| Heat requirement | 1,640,821 | Btu/hr |
| Pressure drop | 50 | psi |
| Power requirement | 4.41 | kW |
| Power requirement | 105.79 | kWh/day |

TABLE 9
Energy requirements, regeneration:

| | | |
|---|---|---|
| Offline time | 12 | Hours |
| Slack time | 1 | Hours |
| Regeneration time | 11 | Hours |
| Mass of bed | 105,139 | Lbs |
| Cp of bed | 0.3 | Btu/lb-° F. |
| Height of bed | 18.22 | ft |
| Height of column | 30.00 | ft |
| Diameter of column | 10.5 | ft |
| Volume of regenerant/(volume | 1.417 | gal/ft³ |
| of bed)² | | |
| Volume of bed | 1,578 | ft³ |
| Volume of regenerant/regen | 26,250 | gal/regen |
| Heat capacity of diesel | 0.43 | Btu/lb-° F. |
| Specific gravity of diesel | 0.83 | |
| Thermal mass liquids | 78,134 | Btu/° F. |
| Total thermal mass | 113,862 | Btu/° F. |
| Temperature in | 60 | ° C. |
| Temperature out | 100 | ° C. |
| Heat load, thermal mass | 8,198,048 | Btu |
| Surface area of vessel | 1,163 | ft² |
| U, insulated, R = 10 | 0.0909 | Btu/hr-ft²-° F. |
| Heat loss to ambient | 15,010 | Btu/hr |
| Total heat loss over 11 hours | 165,105 | Btu |
| Total heat load per regeneration | 8,363,153 | Btu |
| Number of regenerations per day | 2 | |
| Total heat load per day | 16,726,306 | Btu/day |
| Flow of regenerant | 1,250 | BPD |
| Flow of regenerant, with slack time | 40 | GPM |
| Design pressure drop | 100 | psi |
| Power requirement, regeneration | 2.40 | kW |
| Power requirement, regeneration | 52.89 | kWh/day |

It is also necessary to ensure that the required amount of regenerant can flow through the bed within the amount of time allotted for regeneration, uniformly distributed throughout the bed. Because the flow is gravity driven, the proper selection of adsorbent particle size is critical to ensuring a successful design. In addition, this selection will also influence regeneration time.

As described herein, the present invention can be used as a standalone desulfurization unit or in combination with an existing HDS process.

For example, small refineries often need to send their middle distillate to larger refineries for removing organic sulfur. The TSA system described herein can reduce the amount of middle distillate that must be sent out to larger refineries, which also significantly reduces transportation costs as well as the cost of refining the middle distillate charged to the small refinery. Transportation costs are also high because the tankers used to transport clean middle distillate cannot be used to transport high sulfur middle distillate. In addition, some countries may not possess HDS systems and would also benefit from TSA because TSA does not require any complex additional equipment, such as hydrogen generators.

When coupled with an existing HDS system, the TSA system described herein can reduce the amount of middle distillate that must be treated by HDS. Thus, by concentrating the amount of sulfur in middle distillate, the efficiency of HDS is improved. As equilibrium is constant at specific conditions of pressure and temperatures, increasing the concentration of reactant will push the reaction to the right, toward the products.

In general the benefits of the inventive TSA system also reduce the adverse effect of fuel treated by HDS. As discussed above, the HDS system removes many of double bonds in fuel, which further lower the lubricity of the fuel. In a combined HDS and TSA system, the amount of middle distillate to be treated in the HDS system is less, thus lowering the negative effect on lubricity property of the fuel. This in turn lowers the amount of aromatic to be added into the middle distillate treated In HDS to compensate the lower lubricity value, reduces the amount of amine used to purify unused hydrogen (lb amine/lb H₂), and reduces the cost of hydrogen generator due to maintenance, catalysts deactivation etc.

The temperature swing adsorption system described herein can be used to de-bottle neck existing HDS systems, reduce the need for new HDS units, and increase the efficiency of an existing HDS system by utilizing feeds that contain higher sulfur concentrations.

Finally, Table 10 illustrates a comparison of parameters of a temperature swing adsorption system of the present invention as compared with a typical HDS system and a typical ODS system.

TABLE 10
Comparison of Parameters

| Process | Catalyst/adsorbent | Process Parameters | Safety Hazards |
|---|---|---|---|
| HDS | Noble metal | 1) 1^{st} stage P - 650 psig; 2^{nd} | Hydrogen |
| | (ruthenium) | stage P - 850 psig | High Pressure |
| | | 2) T - 300-400° C. | High Temperature |
| | | 3) High maintenance - system | Expensive/toxic |
| | | and reactors | catalysts |
| | | 4) Requires H₂ gas and noble | |
| | | metal catalysts | |
| ODS | Phase transfer catalyst | 1) Ambient pressure | Peroxide |
| | | 2) Temperature varies, typically | High Temperature |
| | | above 80° C. | Non-regenerable |
| | | 3) High maintenance - system | catalysts |
| | | and reactors | |
| | | 4) Requires peroxide and | |
| | | expensive phase transfer catalyst | |
| | | 5) Sulfoxides created cannot be | |
| | | treated by HDS | |
| TSA | Very Stable | 1) Ambient pressure | |
| | Regenerable | 2) Temperature - adsorption 0-100° C.; | |
| | | desorption 10-175° C. | |
| | | 3) Low maintenance - system | |
| | | and reactors | |
| | | 4) No dangerous chemical | |
| | | agents | |

What is claimed is:

1. A method for removing impurities from a petroleum-based fuel composition using temperature swing adsorption, the method comprising the steps of:
a) feeding a petroleum-based fuel composition containing impurities to a series of packed bed columns, wherein the series of packed bed columns comprise an adsorbent capable of adsorbing the impurities from the petroleum-based feed composition at a first temperature;
b) adsorbing the impurities in the petroleum-based feed composition onto the adsorbent in the series of packed columns at the first temperature; and
c) removing treated petroleum-based fuel from the series of packed bed columns.

2. The method according to claim 1, wherein the impurities comprise organo-sulfur compounds.

3. The method according to claim 1, wherein the petroleum-based fuel composition is selected from the group consisting of light distillates, middle distillates, gasoline, diesel, transmix and combinations of one or more of the foregoing.

4. The method according to claim 2, wherein the treated petroleum-based fuel is ultra-low sulfur diesel.

5. The method according to claim 4, wherein the ultra-low sulfur diesel contains less than about 15 parts per million sulfur.

6. The method according to claim 1, wherein the first temperature is within the range of about 0° C. to about 100° C.

7. The method according to claim 1, wherein the pressure as the petroleum-based fuel passes through each of the series of packed bed columns is between about 5 psia and about 120 psia.

8. The method according to claim 1, wherein each bed of the series of packed bed columns operates in an upflow, whereby the petroleum-based fuel composition enters the bottom of each bed and is removed from the top of each bed in the series of packed bed columns.

9. The method according to claim 1, wherein steps a) through c) are repeated until the adsorbent in at least one of the packed bed columns contains a selected concentration of impurities.

10. The method according to claim 9, further comprising the step of taking the at least one bed that contains impurities offline to regenerate the at least one bed.

11. The method according to claim 10, wherein the bed that contains impurities is regenerated by:
d) raising the temperature of the at least one bed that contains impurities to a second temperature at which the impurities are capable of desorbing from the adsorbent; and
e) feeding a regenerant solution to a top of the at least one bed that contains impurities and removing the regenerant from a bottom of the last least one bed, wherein the impurities desorb from the adsorbent into the regenerant solution.

12. The method according to claim 9, wherein steps a) through c) are repeated until the adsorbent in at least one of the packed bed columns reaches equilibrium, whereby the adsorbent in the at least one of the packed bed columns is loaded with impurities.

13. The method according to claim 11, wherein the treated petroleum-based fuel comprises ultra-low sulfur diesel.

14. The method according to claim 13, wherein a portion of the ultra-low sulfur diesel is stored for use as the regenerant.

15. The method according to claim 13, wherein the regenerant is selected from the group consisting of ultra-low sulfur diesel, middle distillate, organic solvents, and combinations of one or more of the foregoing.

16. The method according to claim 11, wherein the second temperature is within the range of about 10° C. to about 175° C.

17. The method according to claim 16, wherein the regenerant is ultra-low sulfur diesel and the second temperature is within the range of about 125° C. to about 175° C.

18. The method according to claim 16, wherein the regenerant is ethanol and the second temperature is within the range of about 70° C. to about 100° C.

19. The method according to claim 1, wherein the adsorbent comprises a porous support impregnated with a sorbent mixture.

20. The method according to claim 19, wherein the porous support is selected from the group consisting of alumina, zirconia, silica gel, molecular sieves and combinations of one or more of the foregoing.

21. The method according to claim 20, wherein the porous support comprises activated alumina.

22. The method according to claim 19, wherein the sorbent mixture comprises a cation selected from the group consisting of chromium, manganese, iron, cobalt, nickel, copper, zinc and combinations of one or more of the foregoing.

23. The method according to claim 22, wherein the sorbent mixture comprises nickel oxide.

24. A temperature swing adsorption system for removing impurities from a petroleum-based fuel composition, the temperature swing adsorption system comprising:
a. a plurality of packed bed adsorbers, wherein the plurality of packed bed adsorbers are arranged in an N+1 configuration, wherein N packed bed adsorbers operate in series and one adsorber is offline, and wherein the plurality of packed bed adsorbers comprise an adsorbent capable of adsorbing impurities from the petroleum-based fuel composition at a first temperature;
b. an inlet for feeding the petroleum-based fuel composition to be treated into the N packed bed adsorbers;
c. an outlet for removing the treated petroleum-based fuel composition from the N packed bed adsorbers; and
d. means for controlling temperature and pressure in the system.

25. The system according to claim 24, wherein each bed of the series of N packed bed columns operates in an upflow, whereby the petroleum-based fuel composition enters the bottom of each bed and is removed from the top of each bed in the series of N packed bed columns.

26. The system according to claim 24, wherein the system is operated until the adsorbent in at least one of the packed bed columns in the series of N packed bed columns contains a selected concentration of impurities.

27. The system according to claim 26, wherein the bed that contains the selected concentration of impurities is taken offline to regenerate the at least one bed.

28. The system according to claim 26, wherein the system is operated until the adsorbent in the at least one of the packed bed columns in the series of N packed bed columns reaches equilibrium, whereby the adsorbent in the at least one of the N packed bed columns is loaded with impurities.

29. The system according to claim 27, wherein the regenerant is selected from the group consisting of ultra-low sulfur diesel, middle distillate, organic solvents, and combinations of one or more of the foregoing.

30. The system according to claim 24, wherein the adsorbent comprises a porous support impregnated with a sorbent mixture.

31. The system according to claim 30, wherein the porous support is selected from the group consisting of alumina, zirconia, silica gel, molecular sieves and combinations of one or more of the foregoing.

32. The system according to claim 31, wherein the sorbent mixture comprises a cation selected from the group consisting of chromium, manganese, iron, cobalt, nickel, copper, zinc and combinations of one or more of the foregoing.

33. The system according to claim 24, wherein the impurities comprise organic sulfur compounds and the treated petroleum-based fuel composition has a sulfur content of less than 15 ppm.

34. The system according to claim 24, wherein the pressure as the petroleum-based fuel passes through each of the series of packed bed columns is between about 5 psia and about 120 psia.

35. An adsorbent for removing impurities from a petroleum-based fuel composition in a temperature swing adsorption process, wherein the adsorbent comprises a porous support impregnated with a sorbent mixture.

36. The adsorbent according to claim 35, wherein the porous support is selected from the group consisting of alumina, zirconia, silica gel, molecular sieves and combinations of one or more of the foregoing.

37. The adsorbent according to claim 36, wherein the porous support comprises activated alumina.

38. The adsorbent according to claim 35, wherein the sorbent mixture comprises a cation selected from the group consisting of chromium, manganese, iron, cobalt, nickel, copper, zinc and combinations of one or more of the foregoing.

39. The adsorbent according to claim 38, wherein the sorbent mixture comprises nickel oxide.

40. The adsorbent according to claim 39, wherein the sorbent mixture comprises a second cation.

41. The adsorbent according to claim 35, further comprising a filler or binder.

42. The adsorbent according to claim 38, wherein the concentration of the sorbent mixture on the porous support is within the range of about 0.01 to about 20 percent by weight.

43. The adsorbent according to claim 42, wherein the concentration of the sorbent mixture on the porous support is within the range of about 1.0 to about 15 percent by weight.

44. The adsorbent according to claim 43, wherein the concentration of the adsorbent mixture on the porous support is within the range of about 2.0 to about 10 percent by weight.

45. The adsorbent according to claim 35, wherein the adsorbent has a BET surface area within the range of about 50 to about 350 m²/gram.

46. The adsorbent according to claim 45, wherein the adsorbent has a BET surface area within the range of about 80 to about 300 m²/gram.

47. The adsorbent according to claim 35, wherein the adsorbent is capable of adsorbing impurities from a petroleum-based fuel composition at a first lower temperature and desorbing the impurities to a regenerant at a second higher temperature.
